(19) United States
(12) Patent Application Publication
(10) Pub. No.: US 2009/0135095 A1
(43) Pub. Date: May 28, 2009

(54) Flat Display Device

(76) Inventor: Toyoshi Kawada, Kunitomi (JP)

Correspondence Address: MCDERMOTT WILL & EMERY LLP, 600 13TH STREET, N.W., WASHINGTON, DC, 20005-3096, US

(21) Appl. No.: 11/922,570

(22) PCT Filed: Aug. 18, 2005
(86) PCT No.: PCT/JP2005/015092

§ 371 Date: Dec. 20, 2007

(51) Int. Cl. G09G 3/28

(52) U.S. Cl. 345/60

(57) ABSTRACT

Provided is a technology for improving heat dissipating performance in a mounting structure of a driver IC chip and a driver module in a flat display device. The plasma display device is provided with a panel (PDP) (74); a structure of a chassis section (73) arranged close to the rear surface side of the panel; a GB-ADM (address driver module) (71) having a flexible substrate (51) whereupon a driver IC chip (56) for driving the electrode of the panel (74) is mounted by GB (gang bonding) method; and a holding plate 75 for holding and fixing the driver IC chip (56) between the chassis section (73) and the holding plate. Furthermore, the GB-ADM (71) is interposed between the chassis section (73) and the holding plate (75), and first and second elastic thermally conductive members (21-1, 21-2) having different characteristics are provided.

### TECHNICAL FIELD

The present invention relates to a technology for a flat display device using a flat display panel such as a plasma display panel (PDP). In particular, it relates to a mounting structure of a driver IC chip for driving electrodes of the panel and a driver IC chip mounting module provided with the driver IC chip (hereinafter, referred to as a driver module and others). Also in particular, the present invention relates to a structure for dissipating heat in the device.

### BACKGROUND ART

Recent progress in development and practical application of a display device using a flat display panel has been remarkable. In particular, an AC-type PDP with a three-electrode-type surface discharge structure has been actively used and applied to a wide-screen TV and the like because of its ease of the screen size increase and the colorization.

As a driver module for driving a PDP, instead of a conventional wire-bonding (hereinafter, referred to as WB) driver module, a gang-bonding (hereinafter, referred to as GB) driver module has been developed, in which higher-density mounting is possible with the aim of size reduction and cost reduction and also an increase in productivity can be expected. Incidentally, a module in which one or more driver IC chips are integrated as a module on a flexible substrate is referred to as a driver module. For example, a driver module for driving an address electrode is referred to as an address driver module (ADM). In particular, an ADM of a WB method is referred to as WB-ADM and an ADM of a GB method is referred to as GB-ADM.

Basically, in the GB driver module, unlike the WB driver module, a driver IC chip is directly mounted on a flexible substrate side, and a heat-dissipating structure for the driver IC chip is not present. It is therefore suggested that a heat-dissipating structure is provided to a part of the flat display device to dissipate heat from the device as a whole.

Examples of the mounting structure of the driver module in the flat display device are disclosed in Patent Document 1 and Patent Document 2.

### Patent Document 1: Japanese Patent Application Laid-Open Publication No. 2000-172191

### Patent Document 2: Japanese Patent Application Laid-Open Publication No. 2001-352022.

### DISCLOSURE OF THE INVENTION

### Problem to be Solved by the Invention

As for the mounting structure of the conventional GB driver module described above, the Patent Document 1 discloses a structure in which a driver IC chip is brought into contact with a heat sink block disposed to be in contact with a panel, thereby dissipating heat. However, the structure for bringing the driver IC chip into reliable and stable contact with the heat sink block is not disclosed and is unspecified.

Also, the Patent Document 2 discloses a structure in which a driver IC chip is held by being pressed to a part of a chassis structure and heat is dissipated from a surface side of the driver IC chip that faces the chassis to a chassis side. However, it has such problems that a heat-dissipating path in the entire device is restricted and also heat-dissipating efficiency is insufficient.

The present invention has been devised in view of the problems described above, and an object of the present invention is to provide a technology capable of improving heat-dissipating performance more than ever before and also achieving excellent thermal and electrical performance and stable quality in terms of long-term reliability, in relation to a mounting structure of a driver IC chip and a driver module on a panel such as a PDP in a flat display device as described above, in particular, to a GB driver module.

### Means for Solving the Problems

The typical ones of the inventions disclosed in this application will be briefly described as follows. To achieve the above-described object, the flat display device according to the present invention includes a mounting structure of a driver IC chip and a driver module on a panel such as a PDP and is characterized by having the following technical means and mounting structure.

In the flat display device, in a mounting structure of a GB driver module for a module including a panel and a chassis section, as means having both of a heat dissipation function and a holding and fixing function for the driver module, first and second elastic thermally conductive members (hereinafter, simply referred to as members) having different characteristics are disposed in front and back of a driver IC chip portion (including a flexible substrate surface) in a mounting structure of a driver module to the chassis structure. By this means, the thermal and electrical performance is improved. In particular, the flat display device has a structure in which the first and second members are disposed to be directly in contact with the driver IC chip portion. Details thereof will be described below.

The device according to the present invention has a configuration comprising: a flat display panel (hereinafter, referred to as an FDP) having electrodes, for example, display electrodes (X, Y) and an address electrode (A); a driver module including a flexible substrate on which a driver IC chip (semiconductor integrated circuit component) connected to the electrodes of the FDP to drive the electrodes is mounted by the GB method; a chassis structure provided near a rear surface side of the FDP; and a member (holding plate) that interposes and presses the driver IC chip between itself and a part of the chassis structure, thereby holding and fixing the driver IC chip. The holding plate has a function to hold and fix the driver module and also has a function to dissipate heat to the outside as well. The driver IC chip has a circuit formation surface connected to a wiring on a flexible substrate side and a non-circuit-formation surface on a side opposite thereto. The driver IC chip is mounted on one surface of the flexible substrate by the GB method.

In the above-described basic configuration, the first and second members are provided. More specifically, an elastic and thermally conductive mechanism structure is provided, which comprises: the first member to be in direct contact with the non-circuit-formation surface of the driver IC chip when the driver module is held and fixed between the chassis section and the holding plate; and the second member to be in indirect contact with the circuit formation surface of the driver IC chip (in other words, to be in direct contact with a driver-IC-chip non-mounting surface of the flexible substrate) when the driver module is held and fixed between the chassis section and the holding plate. The mechanism structure is designed to balance the characteristics in elasticity and thermal conductivity depending on specifications of the two members such as a material and a shape including the thickness thereof, and to achieve both of the holding and fixing performance of the driver module, in particular, the driver IC chip and the heat dissipating performance from that portion. For example, the first member is designed to have a relatively high thermal conductivity (that is, thin shape), and the second member is designed to have a high elasticity (that is, thick shape). Each member is made of, for example, a resin material. In this manner, as the heat-dissipating structure of the device, a path from the driver IC chip to the first member side is taken as a main heat-dissipating path and a path to the second member side is taken as a sub-heat-dissipating path, and vice versa. Further details will be described below by way of example.

(1) Between the chassis structure and the holding plate, a mounting surface of a driver IC chip of the driver module is disposed so as to face the chassis section side. Further, the first member which has a flat shape and high thermal conductivity is interposed between a chassis section surface and a driver IC chip surface, and the second member which has a flat shape and low thermal conductivity is interposed between a driver-IC-chip non-mounting surface of the flexible substrate and the holding plate surface, and then, the holding plate is connected and fixed to the chassis section with a screw or the like.

(2) Between the chassis structure and the holding plate, the mounting surface of the driver IC chip of the driver module is disposed so as to face the holding plate side. Further, the second member which has a flat shape and low thermal conductivity is interposed between the chassis section surface and the driver-IC-chip non-mounting surface of the flexible substrate, and the first member which has a flat shape and high thermal conductivity is interposed between the driver IC chip surface and the holding plate surface, and then, the holding plate is connected and fixed to the chassis section.

(3) The second member is formed of a spring member having mechanical elasticity. For example, spring members are disposed to each of a plurality of driver modules or driver IC chips. Also, for example, the second member is formed of a spring member having mechanical elasticity and an elastic thermally conductive member. For example, for a plurality of driver modules or driver IC chips, a plurality of elastic thermally conductive members for each of them and a common spring member are disposed.

(4) Furthermore, in particular, the FDP is a plasma display panel, and the driver module is an address driver module for driving an address electrode in the electrodes of the plasma display panel. Still further, in the above-described methods (1) to (3), with regard to the position and method of mounting the driver module onto the chassis structure, for example, a driver IC chip is disposed in an area near a lower side of a rear surface of the panel and the chassis. Alternatively, for example, the driver IC chip is disposed in an area of a lower surface of a lower end of the chassis. Further, for example, the driver IC chip is disposed in an area on an extended surface of the chassis on the lower side of the panel.

### EFFECT OF THE INVENTION

The effects obtained by typical aspects of the present invention will be briefly described below. According to the present invention, in relation to a mounting structure of a driver IC chip and a driver module on a panel such as a PDP in a flat display device, heat-dissipating performance can be improved and also excellent thermal and electrical performance and stable quality can be achieved in terms of long-term reliability.

In particular, regarding the GB-ADM, a reduction in cost and an increase in mounting density can be achieved, and even when power consumption of the driver IC chip is relatively large, performance in heat dissipation and holding and fixing performance can be ensured by devising a heat-dissipating path.

### BRIEF DESCRIPTION OF THE DRAWINGS

FIG. 1 is a schematic cross-sectional view of the configuration of a flat display device according to an embodiment of the present invention and a prior-art technology;

FIG. 2 is a perspective view showing a part of the configuration of a three-electrode surface-discharge AC type PDP in the flat display device according to the embodiment of the present invention and the prior-art technology;

FIG. 3 is a block diagram showing the configuration of a panel electrode and a driving circuit in the flat display device according to the embodiment of the present invention and the prior-art technology;

FIG. 4 is an explanatory drawing showing an external view on a rear surface side of a PDP module in the flat display device according to the embodiment of the present invention and the prior-art technology;

FIG. 5 is an explanatory drawing showing an exemplary configuration of a COF-type GB-ADM in the flat display device according to first to third embodiments of the present invention and the prior-art technology;

FIG. 6 is an explanatory drawing showing the configuration of main parts and principle in relation to the solution of the problems in the prior-art technologies, in a mounting structure of the flat display device according to the first embodiment of the present invention;

FIG. 7 is a cross-sectional view in a longitudinal direction of a panel showing a specific mounting structure of the flat display device according to the first embodiment of the present invention;

FIG. 8 is a cross-sectional view in a longitudinal direction of a panel showing a specific mounting structure of the flat display device according to the second embodiment of the present invention;

FIG. 9 is a cross-sectional view in a longitudinal direction of a panel showing a specific mounting structure of the flat display device according to the third embodiment of the present invention;

FIG. 10 is an explanatory drawing showing an exemplary configuration of a TCP-type GB-ADM in the flat display device according to the fourth to sixth embodiments of the present invention and the prior-art technology;

FIG. 11 is a cross-sectional view in a longitudinal direction of a panel showing a specific mounting structure of the flat display device according to the fourth embodiment of the present invention;

FIG. 12 is a cross-sectional view in a longitudinal direction of a panel showing a specific mounting structure of the flat display device according to the fifth embodiment of the present invention;

FIG. 13 is a cross-sectional view in a longitudinal direction of a panel showing a specific mounting structure of the flat display device according to the sixth embodiment of the present invention;

FIG. 14A is an external perspective view seen from a rear-surface side of a panel, showing a state before assembling of a specific mounting structure of a flat display device according to a seventh embodiment of the present invention;

FIG. 14B is a cross-sectional view in a longitudinal direction of a panel corresponding to FIG. 14A;

FIG. 15A is an external perspective view seen from a rear-surface side of a panel, showing a state after assembling of a specific mounting structure of a flat display device according to the seventh embodiment of the present invention;

FIG. 15B is a cross-sectional view in a longitudinal direction of a panel corresponding to FIG. 15A;

FIG. 16 is an external perspective view seen from a rear-surface side of a panel, showing a state before assembling of a specific mounting structure of a flat display device according to an eighth embodiment of the present invention;

FIG. 17A is an external perspective view seen from a rear-surface side of a panel, showing a state after assembling of a specific mounting structure of a flat display device according to the eighth embodiment of the present invention;

FIG. 17B is a cross-sectional view in a longitudinal direction of a panel corresponding to FIG. 17A;

FIG. 18A is a diagram showing a state before assembling of a specific mounting structure of a flat display device according to a ninth embodiment of the present invention;

FIG. 18B is a diagram showing a state after assembling of a specific mounting structure of a flat display device according to the ninth embodiment of the present invention;

FIG. 19A is a diagram showing a state before assembling of a specific mounting structure of a flat display device according to a tenth embodiment of the present invention;

FIG. 19B is a diagram showing a state after assembling of a specific mounting structure of a flat display device according to the tenth embodiment of the present invention;

FIG. 20A is a diagram showing a state before assembling of a specific mounting structure of a flat display device according to an eleventh embodiment of the present invention; and

FIG. 20B is a diagram showing a state after assembling of a specific mounting structure of a flat display device according to the eleventh embodiment of the present invention.

### BEST MODE FOR CARRYING OUT THE INVENTION

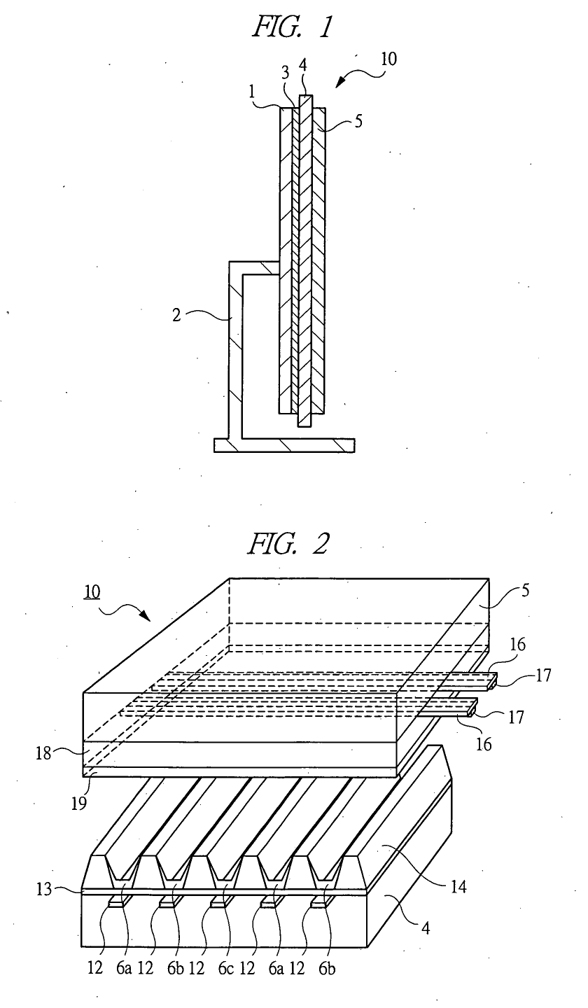

Hereinafter, embodiments of the present invention will be described in detail with reference to the accompanying drawings. Note that components having the same function are denoted by the same reference symbols throughout the drawings for describing the embodiment, and the repetitive description thereof will be omitted. FIG. 1 to FIG. 20 are diagrams for describing the embodiments.

<Overview>

The flat display device according to each embodiment of the present invention is a plasma display device including a PDP as a flat display panel. In this device, in a module including the PDP and a chassis section, as means for ensuring both of a function of heat dissipation and a holding and fixing function for a GB driver module, elastic thermally conductive members are disposed at two positions in front and back of a driver IC chip between the chassis section and a holding plate.

<Configuration of Prior-Art Technology>

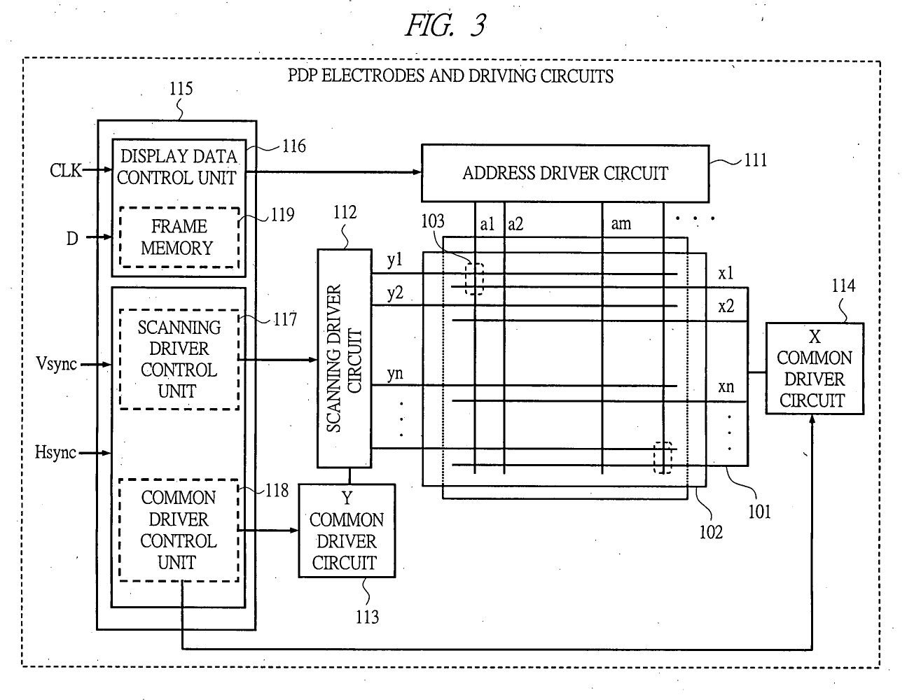

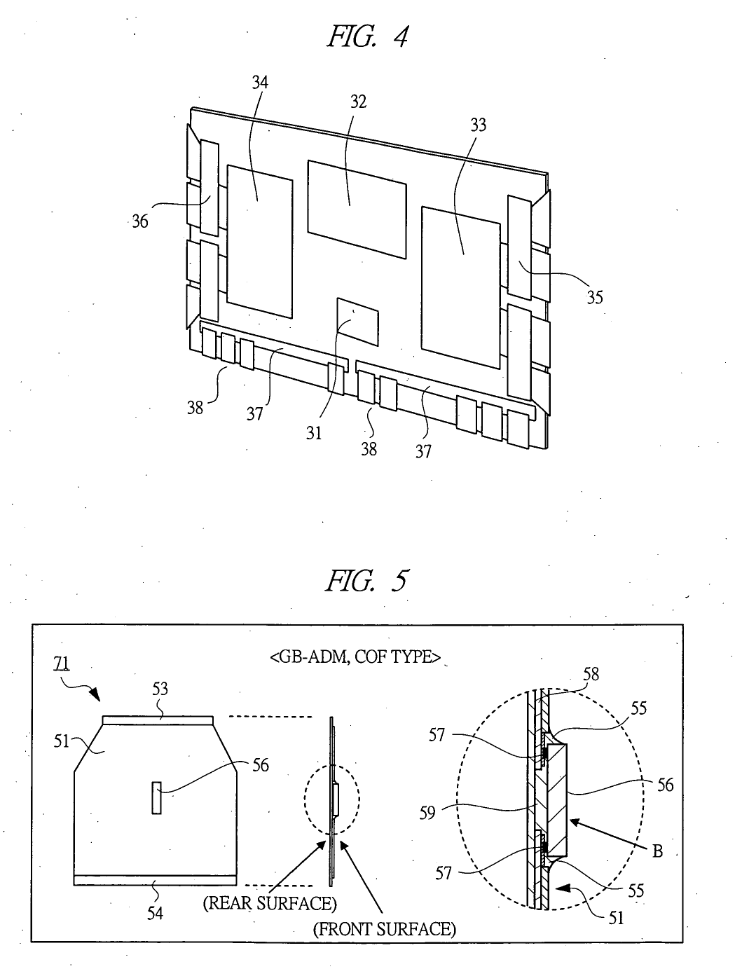

First, for the purpose of comparison with the present embodiments, the configuration of a prior-art technology of the present invention will be described. FIG. 1 is a schematic cross-sectional view in a longitudinal direction of a panel, showing the configuration of a flat display device to which an AC-type PDP panel (or simply referred to as PDP or panel) with three-electrode surface discharge structure is applied (that is, plasma display device) according to the prior-art technology and the embodiments of the present invention. FIG. 2 is a perspective view showing a part of a configuration corresponding to cells of a PDP 10 of the device. FIG. 3 is a block diagram showing the configuration of electrodes of the PDP 10 and main portions in driving circuits for performing a display operation of the PDP in the device. FIG. 4 is an external view of a PDP module seen from a rear surface side thereof, in which a driving circuit and the like are incorporated on a rear surface side of the PDP 10.

<Plasma Display Device>

In FIG. 1, the plasma display device includes the PDP 10, a chassis 1 and others. The PDP 10 is mainly formed of two substrates, that is, a front-surface glass substrate 5 and a rear-surface glass substrate 4, and the PDP 10 is connected and fixed to the chassis 1 with an adhesive 3. The chassis 1 and the PDP 10 are supported by a stand 2 and others.

In FIG. 2, in the PDP 10, the front-surface glass substrate 5 includes an X electrode as a first electrode and a Y electrode as a second electrode. Each of the X and Y electrodes is constituted of a BUS electrode (metal electrode) 17 to be a sustain electrode and a transparent electrode 16. For example, the Y electrode functions as a scanning electrode. The X and Y electrodes are covered with a dielectric layer 18 and a protective layer 19. Also, on the rear-surface glass substrate 4, an address electrode (A) 12 as the third electrode is disposed so as to be orthogonal to the sustain electrodes (X, Y). The address electrode 12 is covered with a dielectric layer 13. With these electrodes (X, Y, A), each display cell that generates discharge light emission is formed at an area intersecting with the address electrode 12 in an area interposed between the electrodes of the respective reference numerals of the sustain electrodes (X, Y).

A plurality of ribs (barrier rib) 14 for forming the areas partitioned into a stripe shape in a longitudinal direction are formed between the front-surface glass substrate 5 and the rear-surface glass substrate 4. In the area partitioned by the ribs 14, phosphors 6 (6a, 6b, 6c) for each of the colors R, G, and B are applied. Each pixel is formed from the display cells of the respective colors. Note that the structure where the ribs are disposed in a lateral direction is also possible.

<Driving Circuit>

In FIG. 3, as to the driving circuits for the PDP 10 having the structure described above, driving circuits (drivers) such as a control circuit 115, an X-electrode driving circuit, a Y-electrode driving circuit, and an address-electrode driving circuit are provided on a front-surface substrate 101 and a rear-surface substrate 102 of the PDP 10.

The front-surface substrate 101 (corresponding to the above-described substrate 5) is provided with a plurality of X electrodes (Xn) as first electrodes and a plurality of Y electrodes (Yn) as second electrodes. The rear-surface substrate 102 (corresponding to the above-described substrate 4) is provided with a plurality of address electrodes (Am).

In this example, in particular, the control circuit 115 includes a display data control unit 116 having a frame memory 119 and driver control units. The driver control units include a scanning driver control unit 117 and a common driver control unit 118. Also, as the drivers, an address driver circuit 111, an X common driver circuit 114, a scanning driver circuit 112, and a Y common driver circuit 113 are provided.

The control circuit 115 generates control signals for controlling the respective drivers of the PDP 10 from externally-inputted interface signals {CLK (clock), D (data), Vsync (vertical synchronization), Hsync (horizontal synchronization)}, thereby controlling the respective drivers. Based on data signals stored in the frame memory 119, the address driver circuit 111 is controlled by the display data control unit 116. Also, the scanning driver circuit 112 is controlled by the scanning driver control unit 117. Furthermore, the X common driver circuit and the Y common driver circuit are controlled by the common driver control unit 118.

Each of the drivers drives the relevant electrodes in accordance with the control signal from the control circuit 115. On a display screen of the PDP 10, address discharge for determining display cells is performed by the driving from the address driver circuit 111 and the scanning driver circuit 112, and then sustain discharge for light emission of the display cells is performed by the driving from the X common driver circuit 114 and the Y common driver circuit 113.

In FIG. 4, as the circuits on the PDP module rear surface, for example, a logic circuit unit 31, a power-supply circuit unit 32, an X-SUS circuit unit 33, a Y-SUS circuit unit 34, an X-BUS circuit unit 35, an SDM circuit unit 36, data bus substrates 37, and address driver circuit units 38 are provided.

In the logic circuit unit 31, the control circuit 115 is mounted. The power-supply circuit unit 32 supplies power to each circuit unit based on inputted power. The X-SUS circuit unit 33 and the Y-SUS circuit unit 34 are circuits for the sustain discharge driving, and the common driver circuits are mounted therein. The X-SUS circuit unit 33 connects the X-BUS circuit unit 35 for relay. The Y-SUS circuit unit 34 connects the SDM circuit unit 36 corresponding to the scanning driver circuit 112. The data bus substrate 37 connects the plurality of address driver circuit units 38, and the address driver circuit unit 38 corresponds to ADM.

<Driver Module>

In the configuration of the driving circuits, for the scanning-side drivers and the address-side drivers, a circuit for selectively applying a driving pulse correspondingly to each electrode of the PDP 10 is required. In general, an element (driver IC chip) in which a circuit having such a function is integrated is used as a main circuit component. For example, an ADM in which a driver IC chip corresponding to the function of the address driver circuit 111 is mounted on a flexible substrate is used.

For example, in a PDP of a 42-inch class, 512 electrodes are disposed on the scanning electrode side, and 3072 electrodes for 1024 pixels (one pixel corresponds to three lines of RGB) are disposed on the address electrode side. It is required to connect the driving circuits correspondingly to each electrode.

Usually, as such a driver IC chip, circuits capable of driving 64 to 192 electrodes per IC are integrated in general. Therefore, eight driver ICs are used for 512 electrodes on the scanning electrode side, and 48 to 16 driver ICs are used for 3072 electrodes on the address electrode side.

In this manner, in order to incorporate many driver ICs as driving circuits in the PDP module, it is required to achieve a high-density mounting structure in which electrical connection to each of many electrodes can be surely made with high reliability and these circuits are compactly mounted so as to be reduced in size and thickness.

For this reason, as a connection mounting method for the driver IC chip to the flexible substrate, a gang-bonding (GB) method in which higher density mounting can be achieved and an increase in productivity can be expected has been increasingly adopted in place of a wire-bonding (WB) method conventionally prevailed in general.

Thus, in the GB method, with a technology of mounting a bear chip IC directly on the substrate, one or more driver IC chips are integrated as a module on a flexible substrate, and this module is incorporated in a display device.

<GB-ADM>

As an example of a driver module in the prior-art technology, FIG. 5 shows a configuration example of an ADM of a GB method (referred to as GB-ADM), in particular, a configuration example of the so-called COF (Chip On Film) type. FIG. 5 shows a developed surface of a flexible substrate 51 of a COF type GB-ADM 71 viewed from the rear side of the PDP 10 and details of its corresponding mounting structure of the driver IC chip in the cross section of the GB-ADM 71.

In the GB method, a driver IC chip 56 is directly mounted by the gang bonding on the surface of the flexible substrate 51 of the GB-ADM 71. The flexible substrate 51 is provided with an output terminal 54 for connection to the PDP 10 extended to an end-face side and an input terminal 53 for connection to a side of a data bus substrate 37. In the case of the COF type, the driver IC chip 56 is mounted on one side surface of the flexible substrate 51.

In the flexible substrate 51, a copper-foil wiring pattern 58 is formed on a base film. In the GB method, when mounting the driver IC chip 56, terminals on its circuit formation surface (surface facing the flexible substrate 51) and corresponding terminals of the wiring pattern 58 on the flexible substrate 51 are connected by bumps 57. At an end of the driver IC chip 56, an underfill 59 is interposed between the connecting portion and the surface of the flexible substrate 51, and a circuit formation surface of the driver IC chip 56. On the flexible substrate 51, an output wiring connected to an output terminal of the driver IC chip 56 is connected for use to the electrodes of the PDP 10 via the output terminal 54 by, for example, thermocompression bonding.

On a surface (rear surface) opposite to the surface of the flexible substrate 51 where the driver IC chip 56 is mounted, a holding plate having connecting and fixing function to a chassis 1 and heat dissipation function to the outside is disposed. A non-circuit-formation surface (B) of the driver IC chip 56 is disposed so as to face the rear surface side of the PDP 10 and the chassis 1.

When mounting the GB-ADM 71 in the prior-art technology, the GB-ADM 71 is connected and fixed to an end portion of the chassis 1, in particular, a lower side area of the panel by a holding plate, with interposing the flexible substrate 51 and the driver IC chip 56 therebetween. The GB-ADM 71 is held and fixed so that the driver IC chip 56 and one surface of the chassis 1 make contact with each other.

### FIRST EMBODIMENT

Next, a first embodiment will be described. A plasma display device according to the first embodiment is provided with a PDP module including the GB-ADM 71 of a so-called COF (Chip On Film) type as a driver module mounting structure. In this configuration, a first elastic thermally conductive member 21-1 having a function to dissipate heat toward the chassis section 73 side is added between the chassis section 73 and the driver IC chip 56 of the GB-ADM 71, and a second elastic thermally conductive member 21-2 having a function to dissipate heat toward the holding plate 75 side is added between the holding plate 75 and a surface of the flexible substrate 51 of the GB-ADM 71. The driver module applied in the first embodiment is similar to the GB-ADM 71 shown in FIG. 5. The basic configuration of each embodiment is similar to that shown in FIG. 1 to FIG. 4.

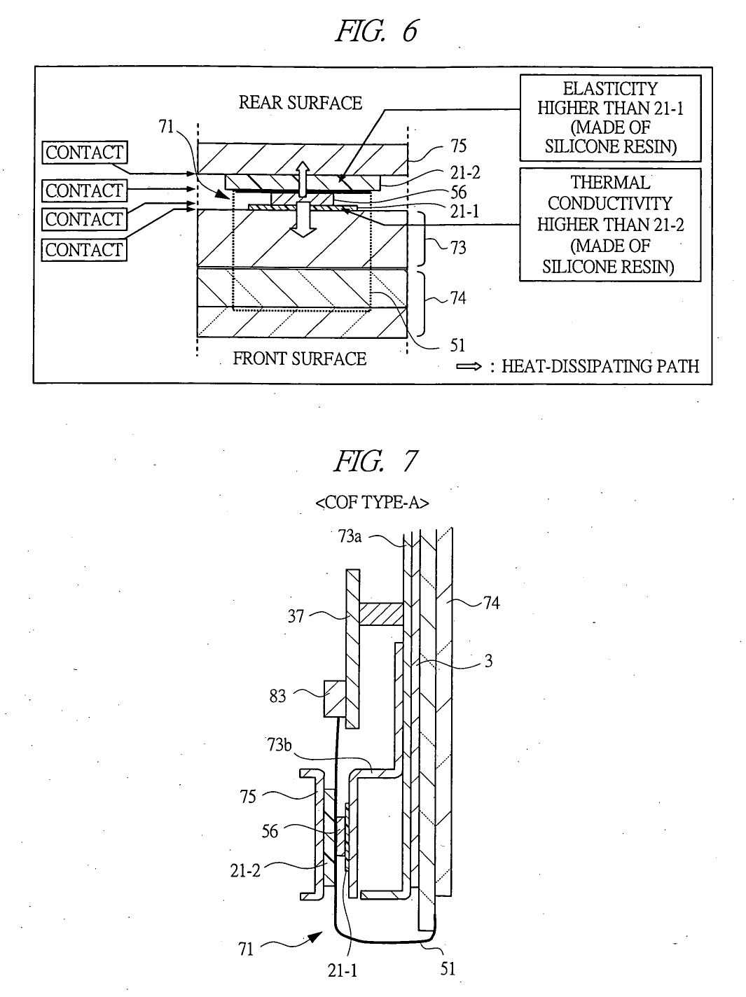

FIG. 6 is an explanatory diagram showing a cross section of a panel screen for describing the configuration of main components and principle in relation to the solution of the problems (including insufficiency in heat-dissipating performance) in the prior-art technologies in a mounting structure of the flat display device according to the first embodiment. In FIG. 6, the positional relation among the components is shown per driver IC chip, and for the purpose of easy understanding, the driver IC chip and the members are enlarged. In FIG. 7, a more specific mounting structure according to the first embodiment is shown. FIG. 7 is a cross-sectional view in a longitudinal direction of a panel showing a mounting structure of the GB-ADM 71.

In FIG. 6 and FIG. 7, from a front-surface side of the device in sequence, a panel 74 (corresponding to the PDP 10), the chassis section 73 (corresponding to the chassis 1 and including a chassis body 73a and a chassis accessory 73b), the first elastic thermally conductive member 21-1, the GB-ADM 71 (including the driver IC chips 56 and the surface of the flexible substrate 51), the second elastic thermally conductive member 21-2, and the holding plate 75 are provided in this order. Between the chassis section 73 and the GB-ADM 71 and between the GB-ADM 71 and the holding plate, the elastic thermally conductive members (21-1, 21-2) having different characteristics in view of elasticity and thermal conductivity are provided, respectively. Also, in particular, a plurality of driver IC chips 56 of the GB-ADM 71 are pressed by the common holding plate 75 so as to be held and fixed onto the chassis section 73.

In the prior-art technology, a heat-dissipating path from the GB-ADM 71 to the chassis section 73 side is only provided. On the other hand, in the first embodiment, members (21-1, 21-2) fabricated separately from the chassis section 73 and the like are provided, and the GB-ADM 71 is held and fixed by the holding plate 75 and the like with interposing these members (21-1, 21-2).

As shown in FIG. 6, as a heat-dissipating path for the heat generated from the driver IC chip 56, a main path is a path to the chassis section 73 side via the first elastic thermally conductive member 21-1 having a relatively high thermal conductivity, and a sub-path is a path to the holding plate 75 side via the second elastic thermally conductive member 21-2 having a relatively low thermal conductivity. Here, in FIG. 6, a frame represented by a dot line shows a surface of the flexible substrate 51 connected between the panel 74 terminal and the data bus substrate 37. Furthermore, although not shown, the holding plate 75 is connected and fixed to the chassis section 73 by fastening means such as a fixing boss and a screw, and thus the GB-ADM 71 and a portion including each of the members (21-1, 21-2) are held and fixed.

The characteristics of the first and second elastic thermally conductive members 21-1 and 21-2 are designed so as to be balanced in the entire device including the holding and fixing portion of the GB-ADM 71 between the chassis section 73 and the holding plate 75. The elasticity of each of the members (21-1, 21-2) influences the performance of holding and fixing the GB-ADM 71, and the thermal conductivity thereof influences the performance of dissipating heat from the GB-ADM 71 to the outside. As the balance of the characteristics of the members (21-1, 21-2), the material and the shape of the members are designed so that the first elastic thermally conductive member 21-1 has a relatively higher thermal conductivity and a relatively lower elasticity than those of the second elastic thermally conductive member 21-2, and the second elastic thermally conductive member 21-2 has a relatively higher elasticity and a relatively lower thermal conductivity than those of the first elastic thermally conductive member 21-1.

The members (21-1, 21-2) are both formed of a material having elasticity to a pressing force such as silicone resin, and a material in which an appropriate amount of metal oxide particles such as micro alumina particles is mixed as thermally conductive filler in order to improve thermal conductivity is used.

Also, as a shape for heat dissipation, the first elastic thermally conductive member 21-1 disposed on the IC mounting surface side of the flexible substrate 51 is configured to have a relatively smaller structural thickness than the second elastic thermally conductive member 21-2 disposed on the opposite side. More specifically, a balance is achieved by making the first elastic thermally conductive member 21-1 have higher thermal conductivity and making the second elastic thermally conductive member 21-2 have higher elasticity.

When holding and fixing the GB-ADM 71 by the holding plate 75 and the members (21-1, 21-2), a state where a surface (rear surface side) of the chassis section 73 and a first surface (front surface side) of the first elastic thermally conductive member 21-1 are in contact with each other is maintained. Similarly, a second surface (rear surface side) of the first elastic thermally conductive member 21-1 and the non-circuit-formation surface (B) (front surface side) of the driver IC chip 56 are in contact with each other, the driver-IC-chip 56 non-mounting surface (rear surface side) of the flexible substrate 51 and a first surface (front surface side) of the second elastic thermally conductive member 21-2 are in contact with each other, and a second surface (rear surface side) of the second elastic thermally conductive member 21-2 and a surface (front surface side) of the holding plate 75 are in contact with each other.

In FIG. 7, the chassis section 73 made of an aluminum-plate material is attached over the entire surface on the rear surface side of the panel 74 by an adhesive 3. The chassis section 73 reinforces the panel 74 and has circuit components such as driving circuits attached thereon. In a lower-side area of the chassis body 73a near a terminal portion of the panel 74, a structure (chassis accessory 73b) having a Z and beam shape and similarly made of an aluminum-plate material is attached. Also, the data bus substrate 37 is disposed nearby correspondingly to the connection of the terminal of the flexible substrate 51. Furthermore, the holding plate 75 is configured by bending the end portion thereof into an L shape and extending the same to have a long length. The planar contact area of each of the members (21-1, 21-2) is at least larger than the area of the driver IC chip 56.

In a device assembling process, basically, the driver IC chip 56 of the GB-ADM 71 is interposed between a flat surface portion of the area projected in a vertical direction of the device rear surface in the beam structure (chassis accessory 73b) on the chassis section 73 side and a flat surface portion of the holding plate 75. Then, the first elastic thermally conductive member 21-1 in a flat-plate shape is interposed between the flat surface portion of the chassis accessory 73b and the non-circuit-formation surface (B) of the driver IC chip 56 facing thereto. Also, the second elastic thermally conductive member 21-2 in a flat-plate shape is interposed between the flat surface portion of the holding plate 75 and the surface of the flexible substrate 51 opposite to the surface on which the driver IC chip 56 is mounted. Then, with each portion of the plurality of GB-ADMs 71 being interposed, the holding plate 75 and the chassis accessory 73b are connected and fixed together by a screw or the like.

With the above-described structure, in the PDP module, the GB-ADM 71 is stably held and fixed between the chassis section 73 and the holding plate 75, and a function to dissipate heat to the sides of the chassis section 73 and the holding plate 75 is provided. As a result, the heat generated from the driver IC chip 56 can be dissipated from the non-circuit-formation surface side of the driver IC chip 56 via the thinner first elastic thermally conductive member 21-1 to the chassis section 73 side and also from the flexible substrate 51 side via the second elastic thermally conductive member 21-2 to the holding plate 75 side. Therefore, in the present plasma display device, both of the heat-dissipating performance and the holding and fixing performance for all of the plurality of driver IC chips 56 can be comprehensively increased.

Also, particularly in this example, the plurality of driver IC chips 56 of the plurality of GB-ADMs 71 are held and fixed by being interposed between the common beam structure (chassis accessory 73b) and the holding plate 75. In this case, even if the structure has any unevenness to some degree such as warpage and protrusions and recessions, such unevenness can be appropriately absorbed by the function of elasticity of each of the members (21-1, 21-2), thereby allowing reliable contact and fixing of each driver IC chip 56.

### SECOND EMBODIMENT

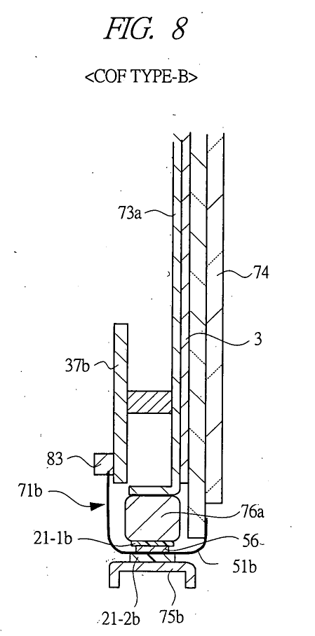

Next, as the embodiments with another configuration based on technical principles similar to those of the configuration according to the first embodiment, second and third embodiments will be described as variations. First, as a second embodiment, FIG. 8 shows a configuration having principles similar to those in FIG. 6 and a different mounting structure of a portion including a GB-ADM 71b. In the second embodiment, a heat sink block 76a in a square shape is provided for the chassis section 73 instead of the chassis accessory 73b as the beam structure so as to make contact with an outer peripheral portion of the chassis body 73a, in particular, with a surface of the L-shaped bent portion on the lower side. Then, to a side surface of this heat sink block 76, in particular, a downward surface side thereof, the driver IC chip 56 of the GB-ADM 71b is held and fixed in the same manner as that in the first embodiment. A plurality of driver IC chips 56 are interposed between the common holding plate 75 and the heat sink block 76 with interposing the first and second elastic thermally conductive member 21-1 and 21-2 therebetween. From the lower side in sequence, a holding plate 75b, a second elastic thermally conductive member 21-2b, a flexible substrate 51b and the driver IC chips 56, a first elastic thermally conductive member 21-1b, the heat sink block 76a, and the chassis body 73a are provided in this order. A data bus substrate 37b is disposed at a position lower than the position of the data bus substrate in the first embodiment. In the second embodiment, the heat dissipating performance and the holding and fixing performance similar to those in the first embodiment can be achieved, and also the size of the flexible substrate 51 can be reduced further compared with the first embodiment, and thus, the further cost reduction can be realized.

### THIRD EMBODIMENT

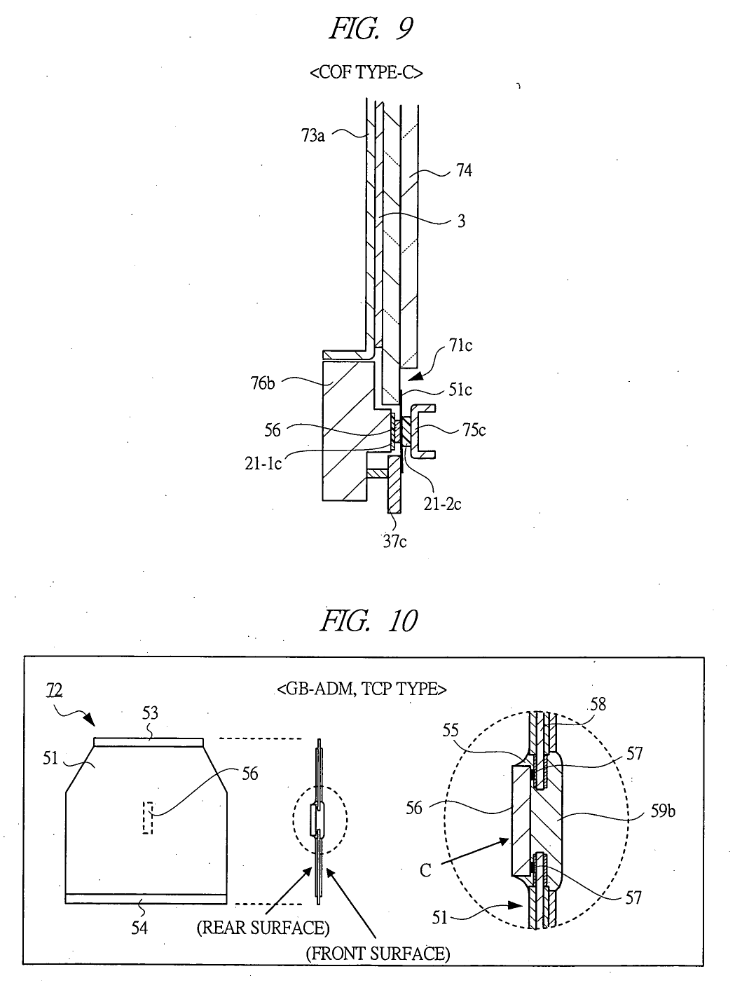

Also, as a third embodiment, FIG. 9 shows a configuration having principles similar to those in FIG. 6 and a different mounting structure of a portion including a GB-ADM 71c. In the third embodiment, a flexible substrate 51c is connected so as not to be bent as much as possible, and the size of the flexible substrate 51 can be further reduced compared with the first and second embodiments. A heat sink block 76b similar to that in the second embodiment but having a different shape is provided so as to make contact with the chassis body 73a. Also, a data bus substrate 37c is provided on an extension surface of the panel 74. A part of the heat sink block 76 is projected outwardly from a lower end surface of the panel 74. Further, on a device front surface side of the heat sink block 76 and near the terminal of the panel 74, a flat contact surface between the driver IC chip 56 and a first elastic thermally conductive member 21-1c is provided. From the front surface side in sequence, a holding plate 75c, a second elastic thermally conductive member 21-2c, the driver IC chip 56 and the flexible substrate 51c, the first elastic thermally conductive member 21-1c, and the heat sink block 76b are provided in this order. In the third embodiment, although the area of the device front surface side including the panel 74 is increased, the size of the flexible substrate 51c can be further reduced, and thus the further cost reduction can be realized.

### FOURTH EMBODIMENT

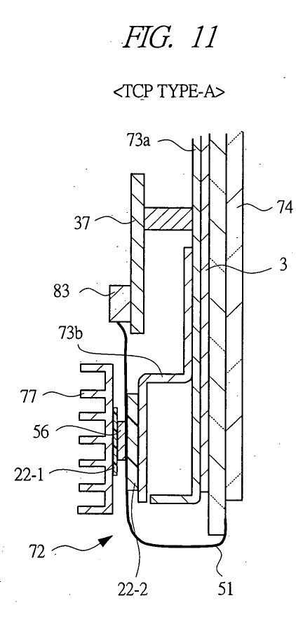

Next, a fourth embodiment will be described. A plasma display device according to the fourth embodiment is configured to have a PDP module including a GB-ADM 72 of a so-called TCP (Tape Carrier Package) type, and a driver module to be applied in the fourth embodiment is a TCP-type GB-ADM 72 shown in FIG. 10. In the fourth embodiment, the driver IC chip 56 is mounted in a direction reverse to a direction of the driver IC chip 56 mounted in the COF-type GB-ADM 71 in the first embodiment. More specifically, of the two IC-mountable surfaces of the flexible substrate 51 in the COF-type GB-ADM 72, the driver IC chip 56 is mounted on one surface so that a non-circuit formation surface (C) of the driver IC chip 56 has the same direction as that of the device rear surface.

FIG. 10 shows an exemplary configuration of the TCP-type GB-ADM 72 in the same manner as that of the case of the COF type in FIG. 5. FIG. 11 is a partial cross-sectional view in a longitudinal direction of a panel showing a specific mounting structure of the plasma display device according to the fourth embodiment in the same manner as FIG. 7.

In FIG. 10, in the GB-ADM 72, since the TCP type has a configuration in which the driver IC chip 56 is mounted in an opening area of the flexible substrate 51, the direction of the mounting surface of the driver IC chip 56 with respect to both of front and rear surfaces of the flexible substrate 51 can be arbitrarily set. In other words, the driver IC chip 56 can be mounted in the same direction as that of the mounting structure of the COF type according to the first embodiment, or vice versa. In this example, the driver IC chip 56 is directly mounted by gang bonding on a surface oriented to the same direction as that of the device rear surface of the flexible substrate 51. From the opening area of the flexible substrate 51, a terminal of the wiring pattern 58 for connection protrudes as a naked finger lead. On one surface of the flexible substrate 51, a terminal on a circuit formation surface of the driver IC chip 56 is bonded to the finger lead by gang bonding and is connected thereto by a bump 57.

In FIG. 11, from the device front surface side in sequence, the panel 74, the chassis section 73 (including the chassis body 73a and the chassis accessory 73b), a second elastic thermally conductive member 22-2, the GB-ADM 72 (driver IC chip 56 and surface of flexible substrate 51), a first elastic thermally conductive member 22-1, and a holding plate (holding plate with a heat sink function) 77 are provided in this order. The first elastic thermally conductive member 22-1 is interposed between a flat surface portion of the holding plate 77 and a non-circuit-formation surface (C) of the driver IC chip 56, and the second elastic thermally conductive member 22-2 is interposed between the chassis accessory 73b and a surface opposite to the IC mounting surface of the flexible substrate 51.

The holding plate 77 is a member having not only a function to press the GB-ADM 72 onto the chassis section 73 so as to hold and fix the same but also a function as a heat sink, that is, a higher heat-dissipating performance than that of the holding plate 75 in the first embodiment. In order to promote heat diffusion to the holding plate 77 side, the holding plate 77 has a relatively large size and a shape such as fins or the like. In particular, the holding plate 77 has a flat surface shape in a surface that faces the driver IC chip 56, and it is provided with a plurality of fins on the opposite side so as to increase the surface area of the holding plate 77.

In FIG. 10 and FIG. 11, in the fourth embodiment, in the flexible substrate 51, a non-circuit-formation surface (C) side of the driver IC chip 56 is oriented to a holding plate 77 side (rear surface) opposite to a chassis section 73 side (front surface), and the diffusion of heat from the driver IC chip 56 is preformed mainly from the holding plate 77 side. Depending on the balance in characteristics between the members (22-1, 22-2), conversely to the first embodiment, a main heat-dissipating path is formed from the driver IC chip 56 toward the holding plate 77, and a sub-path is formed toward the chassis section 73 side. The first elastic thermally conductive member 22-1 is interposed between the driver IC chip 56 and the holding plate 77, and the holding plate 77 has a large size and heat-dissipating fins so as to increase its surface area. In other words, the heat dissipating effect into the air is enhanced. On the other hand, on a circuit formation surface side of the driver IC chip 56, a sealing resin 55 is applied to a portion where the flexible substrate 51 has been removed. The second elastic thermally conductive member 22-2 is interposed between the surface to which the sealing resin 55 is applied and the beam structure (chassis accessory 73b) on the chassis section 73 side.

Similar to the first embodiment, the first and second elastic thermally conductive members (22-1, 22-2) are made of a material having both of elasticity and thermal conductivity. The balance of the characteristics of the members is reversed to that in the first embodiment. In other words, the first elastic thermally conductive member 22-1 on the holding plate 77 side is formed relatively thinner and has a relatively higher thermal conductivity, and the second elastic thermally conductive member 22-2 on the chassis section 73 side is formed to have a relatively higher elasticity. In this manner, the heat dissipating performance for the plurality of driver IC chips 56 at different positions can be increased, and also the holding and fixing performance can be improved.

In the fourth embodiment, since the main heat-dissipating path is present on the holding plate 77 side, compared with the first embodiment, the holding plate 77 is increased in size and is provided with fins. As described above, although the structural restrictions occur to the device, the configuration according to the fourth embodiment can be effectively applied when the driver IC chip 56 cannot be mounted in the same direction as that of the COF type due to the reasons in the manufacture of the TCP type and other factors.

Note that, in this TCP-type mounting, when the driver IC chip 56 is mounted in the same direction (device front surface direction) as that of the COF-type mounting according to the first embodiment, the components can be disposed in the same manner as that of the first embodiment, and similar effects can be achieved.

### FIFTH EMBODIMENT

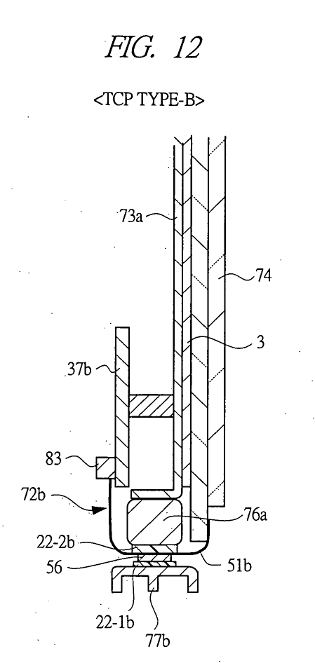

Next, as the embodiments with another configuration based on technical principles similar to those of the configuration according to the fourth embodiment, fifth and sixth embodiments will be described as variations. These fifth and sixth embodiments have principles similar to those in the fourth embodiment, correspond to variations with the technical principles similar to those in the second and third embodiments, respectively, and have features similar thereto. First, as the fifth embodiment, FIG. 12 shows a configuration having a different mounting structure of a portion including a GB-ADM 72b. In the fifth embodiment, to a surface of the square heat sink block 76a provided so as to be in contact with an outer peripheral portion of the chassis body 73a of the chassis section 73, the driver IC chip 56 of the GB-ADM 72b is held and fixed in the same manner as that of the fourth embodiment. From a lower side in sequence, a holding plate 77b, a first elastic thermally conductive member 22-1b, a flexible substrate 51b and the driver IC chip 56, a second elastic thermally conductive member 22-2b, the heat sink block 76a, and the chassis body 73a are provided in this order. The size of the flexible substrate 51b can be reduced and the cost reduction can be realized.

### SIXTH EMBODIMENT

As the sixth embodiment, FIG. 13 shows a configuration having a different mounting structure of a portion including a GB-ADM 72c. In the sixth embodiment, the flexible substrate 51c is connected so as not to be bent as much as possible, and therefore the flexible substrate 51c can be further reduced in size. For the connection of the GB-ADM 72c and the like, a chassis accessory 73c in contact with the chassis body 73a to extend the same is provided. Adjacent to the terminal of the panel 74, a flat contact surface between the driver IC chip 56 and a second elastic thermally conductive member 22-2c is provided on a front surface side of the chassis accessory 73c. From the front surface side in sequence, a holding plate 77c, a first elastic thermally conductive member 22-1c, the driver IC chip 56 and the flexible substrate 51c, the second elastic thermally conductive member 22-2c, and the chassis accessory 73c are provided in this order. Similarly, the flexible substrate 51c can be reduced in size and the cost reduction can be realized.

### SEVENTH EMBODIMENT

Next, a seventh embodiment will be described. The seventh embodiment shows another embodiment based on technical principles similar to those in the first embodiment and the like. In the seventh embodiment, spring members 23 are applied as mechanical elastic members at the position of the second elastic thermally conductive member 21-2 on a side not serving as the main heat-dissipating path in the first embodiment. A driver module to be applied in the seventh and eighth embodiments is similar to the GB-ADM 71.

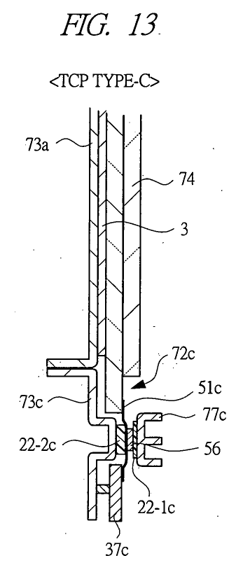

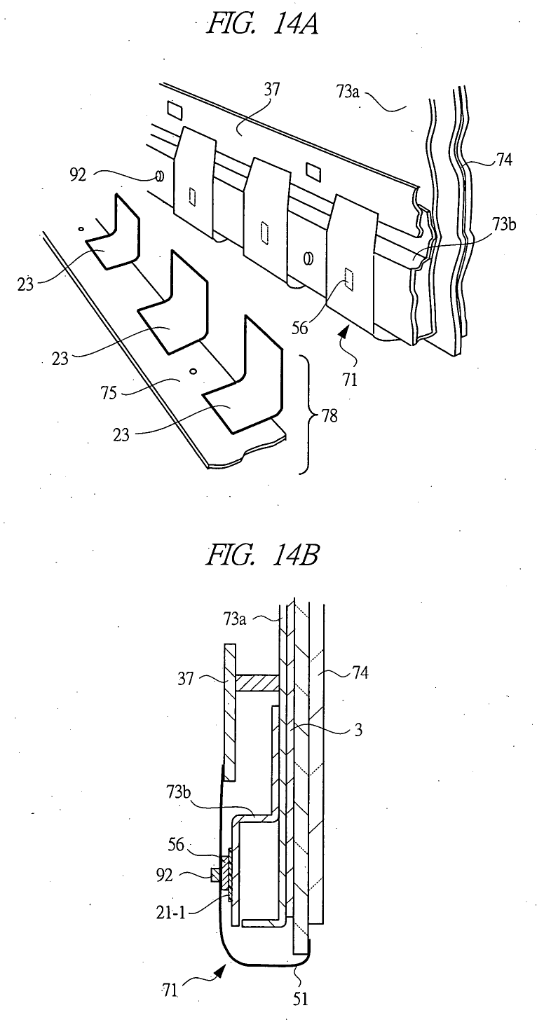

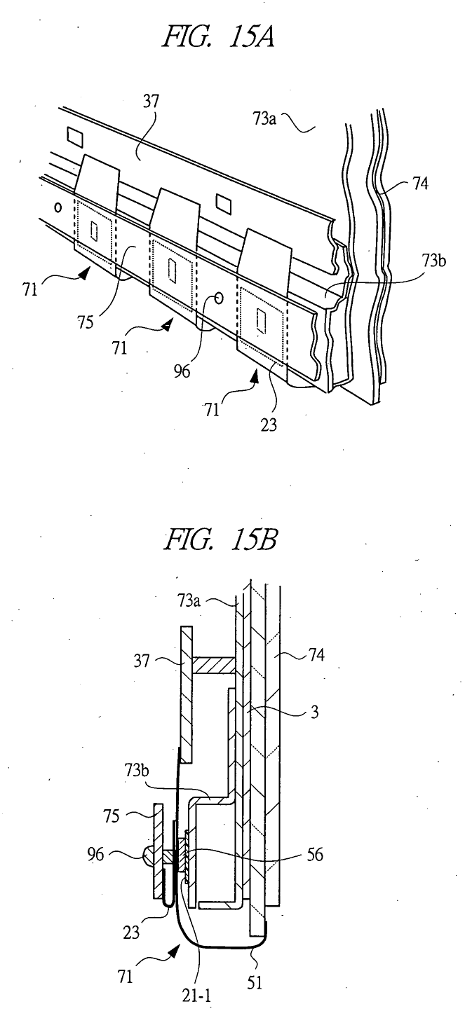

FIG. 14 and FIG. 15 show specific mounting structures of the seventh embodiment. FIG. 14 shows a configuration before the device assembling, in which FIG. 14A is a perspective view seen from a rear-surface side and FIG. 14B is a cross-sectional view in a longitudinal direction of a panel corresponding to FIG. 14A. Also, FIG. 15 shows a configuration after the device assembling, in which FIG. 15A is a perspective view seen from a rear-surface side and FIG. 15B is a cross-sectional view in a longitudinal direction of a panel corresponding to FIG. 15A.

In FIG. 14A, the spring members 23 are attached so as to correspond to the driver IC chips 56 on a surface side opposite to the GB-ADM 71 of the holding plate 75 commonly used for the plurality of GB-ADMs 71. The spring members 23 are shaped so as to planarly cover and press a portion of a surface of the flexible substrate 51 (rear surface) on which each driver IC chip 56 is mounted.

The spring members 23 are made from a rectangular metal-plate material, and are formed by bending the material at a position of approximately 1:2 in its longitudinal direction with approximately 90 degrees and then performing heat treatment such as hardening to provide elasticity. The spring members 23 exhibit a spring-like elasticity against a force of bending the member with more than 90 degrees. A holding plate 78 with a spring member has thermal conductivity by itself because the spring members 23 are made of metal.

The holding plate 78 with a spring member is attached to the holding plate 75 by its narrower flat surface through, for example, welding. A wider flat surface of each spring member 23 faces the surface of the flexible substrate 51. Also, the chassis accessory 73b is provided with a fixing boss 92 corresponding to a screw hole on a holding plate 75 side.

In FIG. 14B, through the connection of the GB-ADM 71, from a device front surface side, the panel 74, the chassis accessory 73b, the first elastic thermally conductive member 21-1, the driver IC chip 56, the surface of the flexible substrate 51, and the fixing boss 92 are provided in this order.

In FIG. 15A, when attaching the holding plate 78 with a spring member, the flat surface portion of each spring member 23 is brought into contact with the surface side of the flexible substrate 51, the holding plate 75 is pressed so that the angle of the spring members 23 becomes deep, and then the holding plate 78 with a spring member is connected and fixed by a screw 96.

In FIG. 15B, after the holding plate 78 with a spring member has been attached, the spring members 23 deeply bent to have a spring elasticity are disposed between the surface of the flexible substrate 51 and the holding plate 75. The first elastic thermally conductive member 21-1 is provided between the non-circuit-formation surface of the driver IC chip 56 and a surface of the chassis accessory 73b so as to form a close contact without even a minute space.

In the above-described configuration, even if the beam structure (chassis accessory 73b) has any unevenness such as warpage and protrusions and recessions, an appropriate amount of pressing force is exerted on each driver IC chip 56 from each spring member 23, thereby allowing close contact and fixing to the beam structure side.

In the spring member 23 as a mechanical elastic thermally conductive member, compared with the members made of a resin material like in the first embodiment, the amount of elastic transition can be easily increased, and unevenness such as warpage and protrusions and recessions can be relatively easily addressed. Also, even for the long-term use, the pressing force can be maintained without plasticity deformation like in the case of resin, and therefore the spring member 23 is excellent also in view of long-term reliability. Furthermore, the holding plate 78 with a spring member has thermal conductivity, and if an emphasis is placed on thermal conductivity rather than elasticity, the thickness of the spring member 23 can be increased. In this manner, depending on the performance to be desired, the balance of the characteristics of the members can be appropriately selected in the configuration.

### EIGHTH EMBODIMENT

Next, an eighth embodiment will be described. In the eighth embodiment, similar to the seventh embodiment, the case where a holding plate 75 is provided with a spring member 24 as a mechanical elastic thermally conductive member will be described. In the configuration according to the eighth embodiment, instead of providing spring members individually to the plurality of driver IC chips 56, a common integral spring member 24 is provided for holding and fixing.

For example, depending on the convenience in manufacturing the spring member 24, in some cases, a spring member having a size corresponding to several spring members can be manufactured and used more easily than the plurality of spring members 23 individually fabricated and fixed to the holding plate 75 like those in the seventh embodiment as a whole. The eighth embodiment is advantageous in such a case.

In this case, diffusion of the pressing force to the plurality of driver IC chips 56 by the common spring member 24 can address the unevenness to some degree if the number of ICs to be collectively handled is small. However, if the number of ICs to be collectively handled is large, the unevenness thereof cannot be absorbed. In such a case, as described in the present example, a thick-plate resin-made elastic thermally conductive member 24-2 can be added between the spring member 24 and a surface portion of the flexible substrate 51 on which the driver IC chips 56 are mounted.

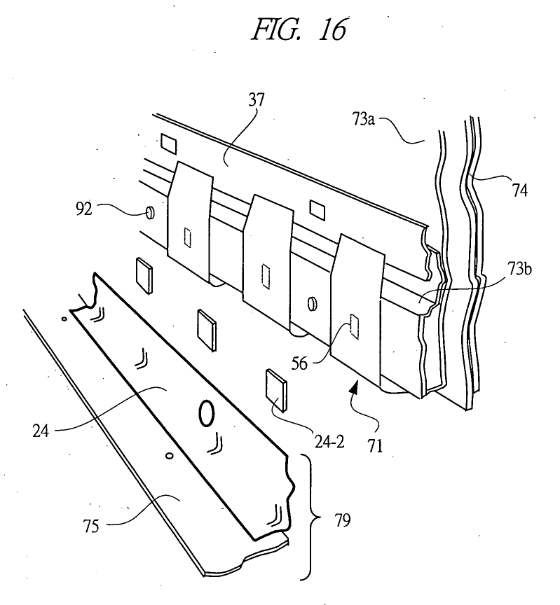

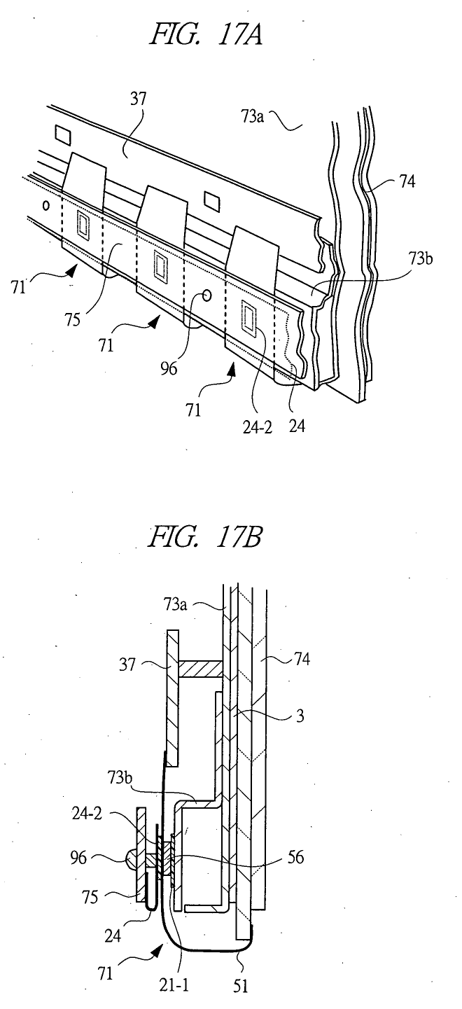

FIG. 16 and FIG. 17 show a specific mounting structure according to the eighth embodiment. FIG. 16 shows the configuration before the device assembling in the same manner as FIG. 14A, and FIG. 17A and FIG. 17B show the configuration after the device assembling in the same manner as FIG. 15A and FIG. 15B.

In FIG. 16, the common spring member 24 is attached on a surface side of the common holding plate 75 facing the plurality of GB-ADMs 71. The spring member 24 has a hole at a position corresponding to the position of the fixing boss 92. Similar to the seventh embodiment, the spring member 24 has spring-like elasticity and thermal conductivity. A plurality of second elastic thermally conductive members 24-2 corresponding to the IC mounting positions are disposed between a holding plate 79 with a spring member and the surface of the flexible substrate 51. A panel cross section in this case is similar to that in FIG. 14B.

In FIG. 17A, when mounting the holding plate 79 with a spring member, the flat surface portion of the spring member 24 is brought into contact with the surface side of the flexible substrate 51, the holding plate 75 is pressed so that the angle of the spring member 24 becomes deep, and then the holding plate 78 with a spring member is connected and fixed by a screw 96.

In FIG. 17B, after the holding plate 79 with a spring member has been attached, the spring member 24 deeply bent and the second elastic thermally conductive members 24-2 are disposed between the surface of the flexible substrate 51 and the holding plate 75.

### NINTH EMBODIMENT

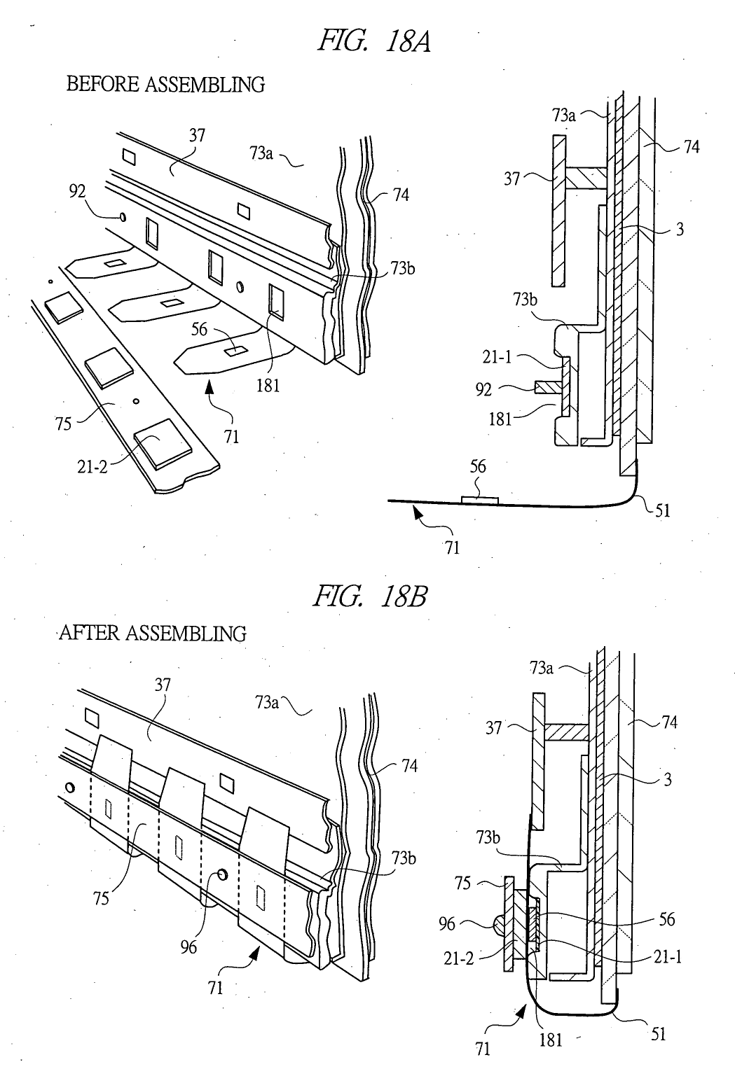

Next, a ninth embodiment will be described. In the ninth embodiment, as another configuration for the same COF-type ADM as that of the first embodiment (FIG. 7), the configuration in which a shape of the chassis accessory 73b is partly devised will be described. FIG. 18A and FIG. 18B show the configuration according to the ninth embodiment, in which FIG. 18A includes a perspective view and a cross-sectional view of the configuration before assembling and FIG. 18B includes a perspective view and a cross-sectional view of the configuration after assembling.

In this configuration, to an area of the surface of the chassis accessory 73b with which the driver IC chip 56 makes a close contact, a concave for accommodating the driver IC chip 56 (IC-chip-accommodation concave portion 181) is provided. With regard to the shape of this concave (181), a size thereof is slightly larger than the driver IC chip 56, and a depth thereof is approximately identical to or slightly larger than the thickness of the driver IC chip 56. Preferably, when the driver IC chip 56 is pressed by a pressing force and fixed in this concave (181), the total thickness of the driver IC chip 56 and the elastic thermally conductive member 21-1 is approximately equal to the depth of the concave (181). However, depending on the strength of the pressing force and the degree of mounting density of the plurality of driver IC chips 56, an optimum depth of the concave (181) may be smaller than the thickness of the driver IC chip 56. Thus, an optimum value is appropriately selected.

According to the ninth embodiment, when the GB-ADM 71 and the driver IC chips 56 are pressed by the holding plate 75, the application of an excessive stress on the driver IC chips 56 can be prevented. Thus, quality and reliability of the driver IC chip 56 itself can be ensured, and connection reliability of each driver IC chip 56 to the connection terminal portion of the flexible substrate 51 can be improved.

### TENTH EMBODIMENT

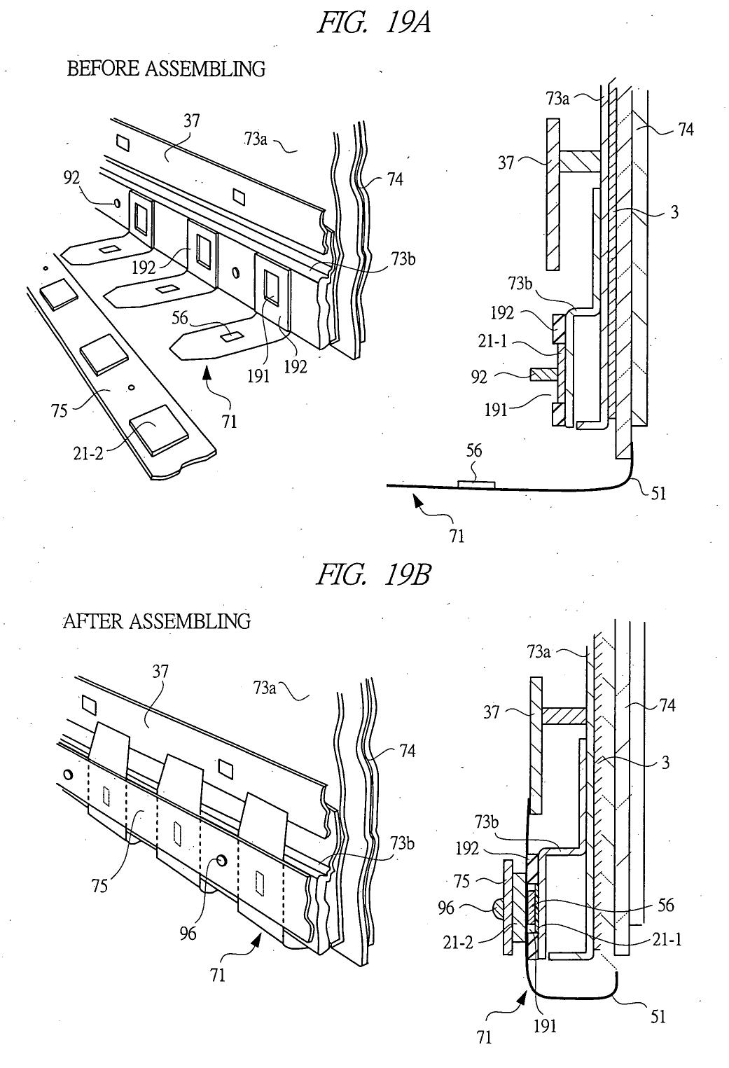

Next, a tenth embodiment will be described. In the tenth embodiment, in a configuration based on principles approximately the same as those in the ninth embodiment, a concave (IC-chip-accommodation concave portion 191) for accommodating the driver IC chip 56 is formed in an insulating plate (192) different from the chassis accessory 73b. FIG. 19A and FIG. 19B show the configuration according to the tenth embodiment, in which FIG. 19A includes a perspective view and a cross-sectional view before assembling and FIG. 19B includes a perspective view and a cross-sectional view after assembling.

To an area of a surface of the chassis accessory 73b with which the driver IC chip 56 makes a close contact, the insulating plate 192 having a hole for accommodating the driver IC chip 56 is inserted. With regard to the shape of the insulating plate 192, the insulating plate 192 has a size approximately equal to or slightly larger than an area where the surface of the flexible substrate 51 makes contact with the surface of the chassis accessory 73b when the GB-ADM 71 is pressed by the holding plate 75 onto a chassis accessory 73b side, and it has the thickness approximately equal to or slightly thicker than the thickness of the driver IC chip 56. Preferably, the total thickness of the driver IC chip 56 and the elastic thermally conductive member 21-1 is approximately equal to the thickness of the insulating plate 192 when the driver IC chip 56 accommodated in the hole (191) is pressed and fixed by the pressing force. However, even in this case, depending on the strength of the pressing force and the degree of the mounting density of the plurality of driver IC chips 56, an optimum thickness of the insulating plate 192 may be smaller than the thickness of the driver IC chip 56. Thus, an optimum value is appropriately selected.

According to the tenth embodiment, similar to the ninth embodiment, the application of an excessive stress on the driver IC chips 56 and the connection terminal portions thereof can be prevented. Thus, quality and reliability thereof can be improved, and the surface of the flexible substrate 51 forming the GB-ADM 71 can be insulated and protected. As a configuration of an insulating protective film formed on the surface of the flexible substrate 51, a solder resist is applied onto a copper foil in many cases. Depending on the method of manufacturing the solder resist, however, application thickness is largely varied and minute pin holes are frequently mixed, and therefore sufficient insulation may not be achieved. In such cases, the presence of the insulating plate 192 can prevent the surface of the flexible substrate 51 from making direct contact with the surface of the chassis accessory 73b, thereby ensuring insulation.

### ELEVENTH EMBODIMENT

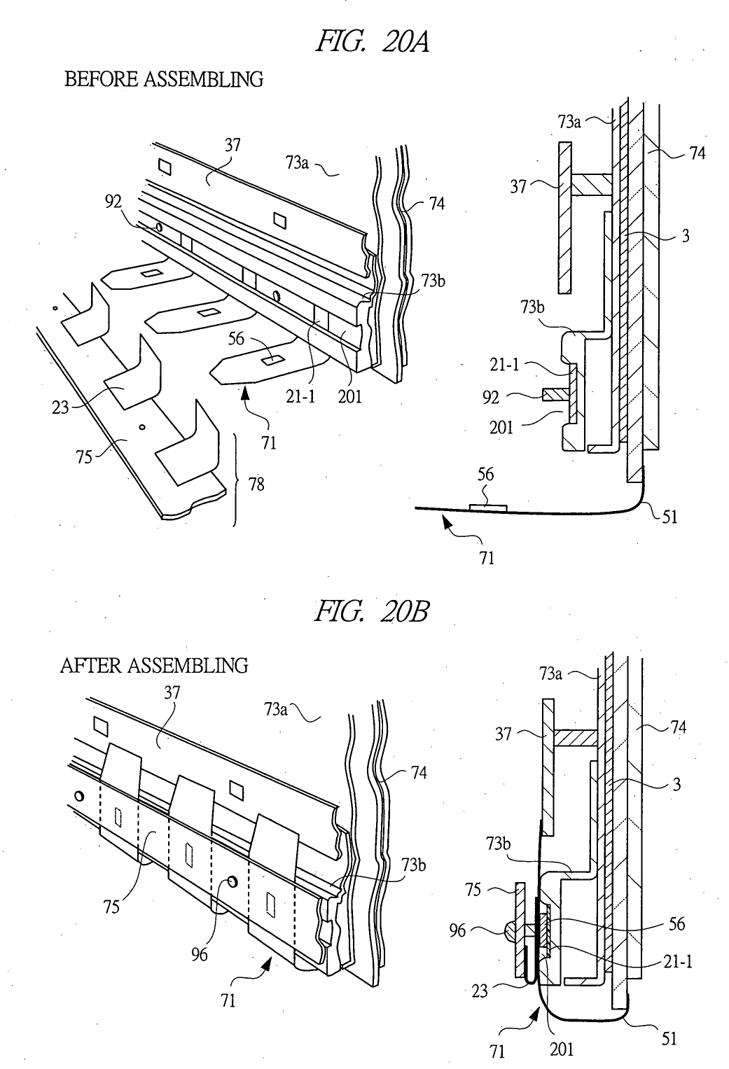

Next, an eleventh embodiment will be described. In the eleventh embodiment, in a configuration based on principles approximately identical to those in the ninth and tenth embodiments, a concave (181) for accommodating the driver IC chips 56 is formed to have a horizontal-stripe shape with respect to the surface of the chassis accessory 73b. FIG. 20A and FIG. 20B show the configuration according to the eleventh embodiment, in which FIG. 20A includes a perspective view and a cross-sectional view before assembling and FIG. 20B includes a perspective view and a cross-sectional view after assembling.

With regard to the shape of a concave portion with a horizontal stripe shape (IC-chip-accommodation concave 201), the concave (201) has a vertical width slightly larger than the vertical size of the driver IC chip 56, and it has a depth approximately equal to or slightly thicker than the thickness of the driver IC chip 56. Preferably, similar to the ninth and tenth embodiments, when the driver IC chip 56 is pressed by a pressing force and fixed in this concave (201), the total of the thickness of the driver IC chip 56 and the elastic thermally conductive member 21-1 is approximately equal to the depth of the concave (201). Depending on the strength of the pressing force and the degree of mounting density of the plurality of the driver IC chips 56, however, an optimum depth of the concave (201) may be smaller than the thickness of the driver IC chip 56. Thus, an optimum value is appropriately selected.

According to the eleventh embodiment, similarly, the application of an excessive stress to the driver IC chips 56 can be prevented. Thus, quality and reliability of the driver IC chips 56 and their terminal connection portions can be increased.

Furthermore, as the method for manufacturing the groove-shaped concave (201) in a lateral horizontal direction, various methods can be employed such as a method in which grooves are pressed on the surface of the chassis accessory 73b, a method in which grooves are successively cut on the surface, and further a press-molding method capable of easily forming a long groove-shaped member by pressing a metal material by a mold frame having a predetermined cross-sectional shape. Therefore, the eleventh embodiment has a feature of excellent processability. Still further, since the concave (201) extends in a lateral direction, even when a mounting position shift of the driver IC chip 56 and a mounting position shift of the chassis accessory 73b on the chassis itself (73a) occur, such shifts can be easily absorbed, and these unevenness can be easily addressed. Still further, there is also an effect in which the surface of the flexible substrate 51 on which the GB-ADM 71 is to be formed can be insulated and protected.

With regard to the elastic thermally conductive members at two positions in each embodiment, in addition to those made of silicone resin, a thermally conductive member of a phase-change type whose phase changes from solid to liquid in accordance with an increase in temperature can also be used. In the case of the phase-change-type thermally conductive member, since a change to liquid occurs when the temperature reaches a certain temperature or higher, the contact performance with the heat-dissipating structure is significantly increased, and thus such a phase-change-type thermally conductive member is advantageous when much emphasis is placed on the heat-dissipating performance. In particular, by using the phase-change-type thermally conductive member as an elastic thermally conductive member disposed on the main heat-dissipating path side, an excellent heat-dissipating effect can be achieved. Also, as an elastic thermally conductive member disposed on the main heat-dissipating path side, a thermally conductive member of a gel or grease type exhibiting a liquid phase regardless of the temperature change or that of an oil-compound type can be used. Also in this case, an excellent heat-dissipating effect can be achieved.

As described in the foregoing, according to each embodiment, in the plasma display device, as a mounting structure of a driver IC chip and a driver module for driving electrodes (X, Y, A) of the PDP 10, particularly when power consumption of the driver IC chip is relatively large, the heat dissipating performance and the holding and fixing performance can be sufficiently ensured, and stable quality can be achieved also in view of long-term reliability. Also, the cost reduction and high-density mounting can be achieved particularly in the GB-ADMs 71 and 72.

Also, although an ADM for driving an address electrode is taken as an example in the foregoing embodiments, as another embodiment, the present invention can be similarly applied to a driver module for driving another electrode such as a scanning electrode.

Furthermore, although not particularly shown, even when electric components other than the driver IC chips 56 such as resistors and capacitors are mounted on the flexible substrate 51, a configuration similar to that according to each embodiment can be applied, and similar performance and effects can be achieved.

Note that a plasma display panel (PDP) has been taken as the flat display panel (FDP) in the detail description of the applied technology. However, based on the principles and configuration, the present invention can be applied to other FDPs such as a liquid-crystal display panel and an EL display panel as a matter of course.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention can be used for a module including a panel, a chassis and a driver module and for a display device including the module such as a plasma display device.

1. A flat display device comprising:
a flat display panel having an electrode;
a driver module including a driver IC chip connected to the electrode of the flat display panel to drive the electrode and a flexible substrate having the driver IC chip mounted by a gang bonding method;
a chassis structure provided near a rear surface side of the flat display panel; and
a holding plate fixing the driver IC chip with interposing the drive IC chip between the holding plate itself and the chassis structure,
wherein the driver IC chip has a circuit formation surface connected to a wiring on a side of the flexible substrate and a non-circuit-formation surface on a side opposite to the circuit formation surface, and
in fixing the driver module between the chassis structure and the holding plate, a first elastic thermally conductive member in direct contact with the non-circuit-formation surface of the driver IC chip and a second elastic thermally conductive member in indirect contact with the circuit formation surface of the driver IC chip are provided.

2. The flat display device according to claim 1,
wherein the first elastic thermally conductive member is configured of a material so as to have a thermal conductivity higher than a thermal conductivity of the second elastic thermally conductive member.

3. The flat display device according to claim 1,
wherein the first elastic thermally conductive member is formed and disposed so as to have a shape with a thickness smaller than a thickness of the second elastic thermally conductive member.

4. The flat display device according to claim 1,
wherein the first and second elastic thermally conductive members are made of a resin material composed mostly of resin and mixed with an appropriate amount of a thermally conductive filler made of a material having a thermal conductivity higher than a thermal conductivity of the resin material.

5. The flat display device according to claim 4,
wherein the thermally conductive filler is a fine-particle powder formed of metal or metal oxide.

6. The flat display device according to claim 1,
wherein, of the first and second elastic thermally conductive members, at least the first elastic thermally conductive member is formed of a phase-change material whose phase changes from a solid state to a liquid state with an increase in temperature.

7. The flat display device according to claim 1,
wherein the first elastic thermally conductive member is formed of a gel-type material or a grease-type material.

8. The flat display device according to claim 1,
wherein the second elastic thermally conductive member is formed of a spring member.

9. The flat display device according to claim 1,
wherein the second elastic thermally conductive member is formed of a combination of a resin material and a spring member.

10. The flat display device according to claim 1,
wherein the driver IC chip is plural in number, and
the second elastic thermally conductive member is formed of a plurality of spring members which independently exert an elastic force on each of the plural driver IC chips.

11. The flat display device according to claim 1,
wherein a concave structure adjacent to at lease two sides of the driver IC chip and capable of accommodating at least a part of the driver IC chip is provided.

12. The flat display device according to claim 11,
wherein the concave structure is formed by combining insulating plates.

13. The flat display device according to claim 1,
wherein the flat display panel is a plasma display panel, and
the driver module is a module for driving an address electrode of the plasma display panel.
